(19) United States
(12) Patent Application Publication
(10) Pub. No.: US 2015/0166325 A1
(43) Pub. Date: Jun. 18, 2015

(54) Riding cushion for placement on a mount

(71) Applicant: E. A. MATTES GmbH, Muhlheim an der Donau (DE)

(72) Inventor: Peter Mattes, Mahlstetten (DE)

(21) Appl. No.: 14/559,439

(22) Filed: Dec. 3, 2014

(30) Foreign Application Priority Data
Dec. 17, 2013 (DE) 10 2013 114 258.3

(51) Int. Cl. B68C 1/12; B68C 1/02

(52) U.S. Cl. CPC B68C 1/12; B68C 1/02

(57) ABSTRACT

The invention relates to a riding cushion for placement on a mount comprising two lateral parts made from a flexible material, such as a textile web. The two lateral parts are preferably connected to each other along a central line. In order to release the spinal cord, particularly the withers of the mount, a concave formed part is fastened, preferably comprising plastic and/or metal in or at the cushion in the area of and along the central line thereof. This formed part is bent and/or curved upwards towards the frontal end of the cushion in order to follow the withers of the mount.

### CROSS REFERENCE TO RELATED APPLICATIONS

This patent application claims priority to German Patent Application 10 2013 114 258.3 filed on Dec. 17, 2013.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The present invention relates to a mountable riding cushion.

2. Background of the Invention

The invention relates to a riding cushion to be placed onto a mount with two lateral parts, which preferably comprises a textile web, with both lateral parts being connected to each other.

Such riding cushions, also called pillions, are widely known. An example for such a pillion is described in DE 20 2013 005 984 U1.

It is problematic in such pillions that they are used regularly without a solid saddle-tree and are placed flat onto the back of the mount. Here, the pillions are only poorly or not at all formed anatomically and thus offer few or no wiggle-room at the bottom for the spinal cord of the mount. The weight of the rider and the strap projection can also press onto the spinal cord of the mount, so that these pillions must regularly be cushioned with thickly upholstered saddle pads. It is additionally problematic that based on the missing saddle-tree little lateral support is provided on the back of the mount and thus the pillions can easily slip. This slippage is dangerous in tightly fastened stirrups.

The solution of this problem described in the above-mentioned DE 20 3013 005 984 U1 provides placing an anatomically shaped interim part comprising a flexible material underneath the two lateral parts of the pillion. The two lateral parts of the pillion, located at a distance in reference to each other, are equipped at their bottom with chambers, which can be individually upholstered. Additional chambers develop between the upper and the lower parts of the pillion composed in this fashion. By filling these chambers with a suitable upholstery material and/or flexible plastic plates the entire pillion develops a clear channel along a central line, with its height also increasing with the height of the upholstery material and/or the flexible plastic plates used. This way, the spinal cord of the horse can be kept clear.

In this solution it is problematic, on the one side, that relatively much upholstery material and/or sufficiently flexible plastic plates must be used, in order to ensure a sufficiently high, clear central channel. On the other side, when using upholstery material it is not always ensured that the central channel actually remains clear and the spinal cord and particularly the withers of the mount are not impinged with an undesired pressure.

This shall be attained with the present invention.

### BRIEF SUMMARY OF THE INVENTION

In a preferred embodiment, a cushion for placement on a mount with two lateral parts made from a flexible material, particularly a textile material, which are connected to each other, wherein a formed part is fastened in or at the cushion in the area and at least approximately along the entire central line of the cushion.

In another preferred embodiment, the cushion as described herein, wherein the formed part is embodied at least U-shaped or bowl-shaped seen in the cross-section.

In another preferred embodiment, the cushion as described herein, wherein the formed part shows a first rear section with a length, and a second frontal section with a length, with the frontal section extending in one piece from the rear section curved or bent upwards.

In another preferred embodiment, the cushion as described herein, wherein the formed part widens from the rear section towards the frontal section with a rear width and a frontal larger width.

In another preferred embodiment, the cushion as described herein, wherein the formed part comprises a bowl-shaped bend, with its radius in the frontal section being smaller than the radius in the rear section.

In another preferred embodiment, the cushion as described herein, wherein the formed part is made from plastic or metal or a combination of these materials.

In another preferred embodiment, the cushion as described herein, wherein the cushion comprises a pocket-like opening along its central line, in which the formed part is inserted.

In another preferred embodiment, the cushion as described herein, wherein the pocket-like opening is sewn or otherwise closed at a frontal or rear end of the cushion.

In another preferred embodiment, the cushion as described herein, wherein that the pocket-like opening can be closed by a Velcro-closure.

In another preferred embodiment, the cushion as described herein, wherein the cushion comprises on its top and/or bottom fastening means for fastening the formed part.

In another preferred embodiment, the cushion as described herein, wherein the cushion comprises strap openings on each of the two lateral parts for guiding straps through them.

In another preferred embodiment, the cushion as described herein, wherein each of the two lateral parts of the cushion show upholstery.

### BRIEF DESCRIPTION OF THE DRAWINGS

FIG. 1 is a line drawing evidencing the cushion with lateral parts and a formed part, in the assembled state placed in a pocket-like opening, in a perspective view.

FIG. 2 is a line drawing evidencing the cushion of FIG. 1 with the pocket-like opening seen from the front.

FIG. 3 is a line drawing evidencing a similar illustration as FIG. 2, with however the formed part not yet completely inserted into the pocket-like opening.

FIG. 4 is a line drawing evidencing the cushion with the inserted formed part in a top view.

FIG. 5 and FIG. 5a are line drawings evidencing two different views from the bottom of the cushion with the inserted formed part.

FIG. 6 is a line drawing evidencing the formed part inserted in and/or to be inserted into the cushion of FIGS. 1 to 5 in a perspective side view.

FIG. 7 is a line drawing evidencing the formed part of FIG. 6 in a perspective illustration with view upon the formed part from the bottom.

FIG. 8 is a line drawing evidencing the formed part of FIGS. 6 and 7 in a cross-section.

FIG. 9 is a line drawing evidencing a concrete exemplary embodiment of a formed part in various views.

### DETAILED DESCRIPTION OF THE INVENTION

For the purposes of this patent application, the terms “pillion” and “cushion” shall be used interchangeably.

The invention intends to provide a riding cushion and/or cushion, which ensures in any case that the spinal cord of the mount is kept clear.

The cushion according to the invention essentially provides two lateral parts made from a flexible material, particularly a textile web, with the two lateral parts being connected to each other. In or at the cushion, in the area or approximately over the entire central line of the cushion, a concavely formed part is fastened, particularly in itself being stiff or nearly stiff.

By using the concavely formed part in or at the cushion, depending on the shape of the concave wall of the formed part, a more or less clear central channel can be formed over the spinal cord of the mount.

In a further development of the invention it is provided that the bowl-shaped formed part is made of metal or plastic or a mixture of these materials. If the formed part is made from plastic, it is advantageous to injection-mold it into its shape in a suitable mold. Another option is to deep-draw this formed part. A plastic part is also advantageous in that compared to metal it is lighter and thus forms a better wearing support for the mount. When using metal as the material the formed part can be punched out of a metal plate and subsequently deformed. The formed part may show, seen in its cross-section, at least a U-shaped or an approximately bowl shaped form. Although it has previously been mentioned that the formed part comprises a single material, here a material combination, e.g., plastic and metal, may also be used.

The bowl-shaped formed part comprises here a first, rear section with a length L1 and a second, frontal section with a length L2, with the frontal section being curved or angled, extending upwards in one piece from the rear section, e. g. at an angle from approximately 15° to approximately 40°. Here, the frontal section shall be understood as the area, which is closer to the head of the mount when the formed part is in use. The rear section is however facing away from the head of the mount. By this angling of the formed part in the direction of the frontal section it is easily possible that the cushion according to the invention follows the neck of the mount and here also effectively clears parts of the upper spinal cord, particularly the withers towards the head of the horse.

An optimal anatomic adjustment of the cushion to the back and/or the neck of the horse is here achieved such that the formed part preferably slightly widens from the rear section towards the frontal one, such as widens conically. It is also beneficial when the formed part shows a bowl-shaped curve, with its radius R1 in the frontal section being smaller than a radius R2 in the rear part of the formed part. In another embodiment it is provided that the bowl-shaped wall of the formed part towards the frontal end is embodied considerably lower than towards the rear end.

The scope of the present invention includes fixing the formed part inside the cushion or at the cushion. If the formed part shall be fastened within the cushion, the cushion must be provided along its central line with a pocket-like opening, into which the formed part can be inserted. Beneficially, this pocket-like opening is closed at the rear end of the cushion, e.g., sewn. At the frontal side of the cushion, however, an opening is provided, which can be sealed, by which the formed part can be inserted into the pocket-like opening. When the formed part is inserted, this pocket-like opening can be closed, for example by a Velcro-closure. If the formed part within the pocket-like opening shall not be optionally exchanged, of course the frontal opening can also be permanently closed, e. g., sewn.

In another variant of the invention the bowl-shaped formed part can be fixed underneath the cushion, for example by Velcro-closure or push buttons or the like. However, in this variant it must be ensured that underneath the formed part here another saddle pad or the like is placed onto the back of the mount, so that the formed part is not directly resting on the back of the mount. In order to avoid this, it is suggested to provide a saddle pad underneath the cushion with an integrated, plate-shaped device for distributing pressures and stabilization, as disclosed for example in the European patent EP 1 752 414.

Similarly, such a formed part can be placed above the cushion. However, then a saddle pad or the like should also be placed between the rider and a concave formed part.

It has proven beneficial for the cushion to show openings for straps at each of the two lateral parts, in order to allow guiding one or more straps through them. Additionally, the cushion may also show upholstery on both lateral sides.

### DETAILED DESCRIPTION OF THE FIGURES

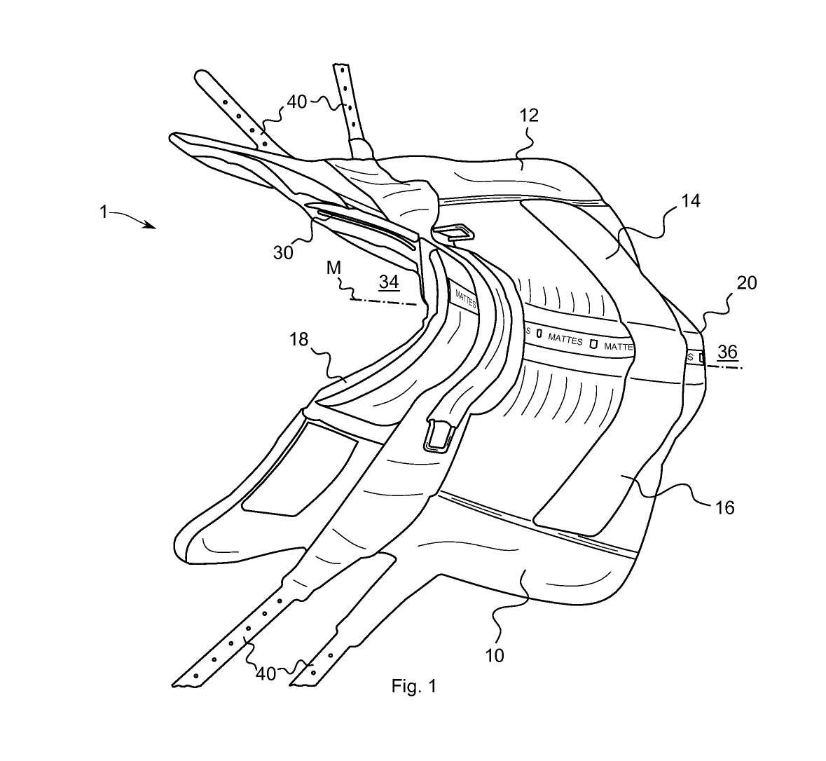

FIG. 1 shows a cushion 1 in a perspective view from the front. The cushion 1 comprises two lateral parts 10, 12, which are made from a textile web or another flexible material. The textile web may be quilted, for example. Other materials are also possible for the lateral parts 10, 12. As discernible, the two lateral parts 10, 12 are connected to each other along a central line M, which also forms an axis of symmetry of the cushion 1. The lateral parts 10, 12 may be provided with upholstery 14, 16. In the perspective view of FIG. 1, at the left the frontal end 34 of the cushion 1 is located, thus the section pointing towards the head of the mount. The rear end 36 of the cushion 1 is located at the right of FIG. 1.

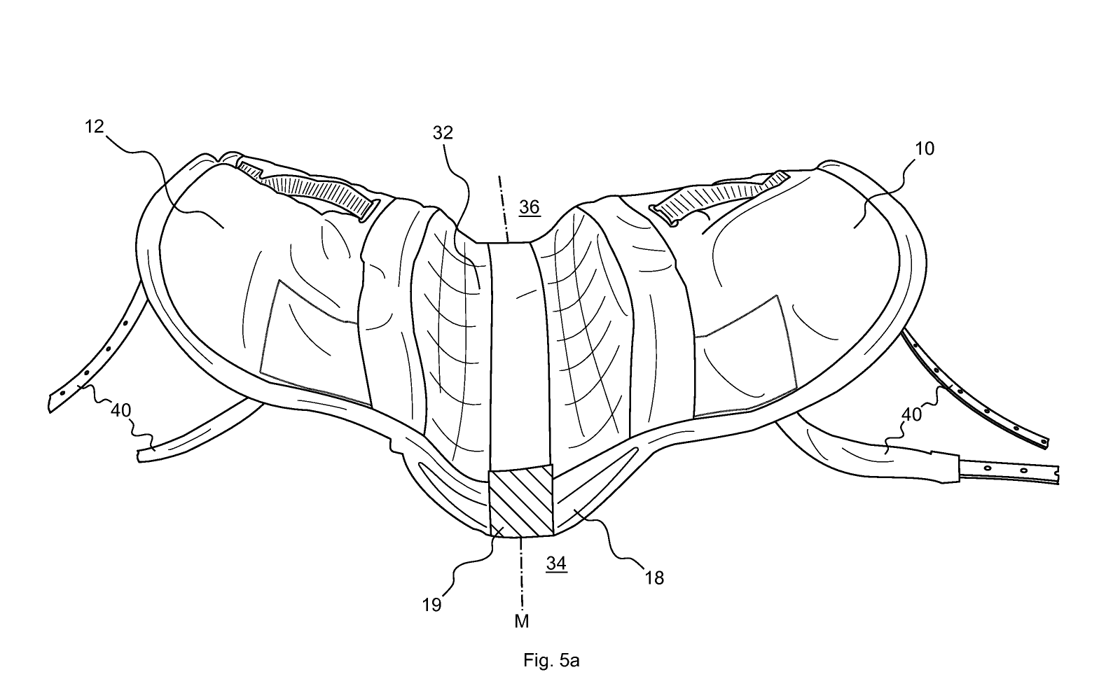

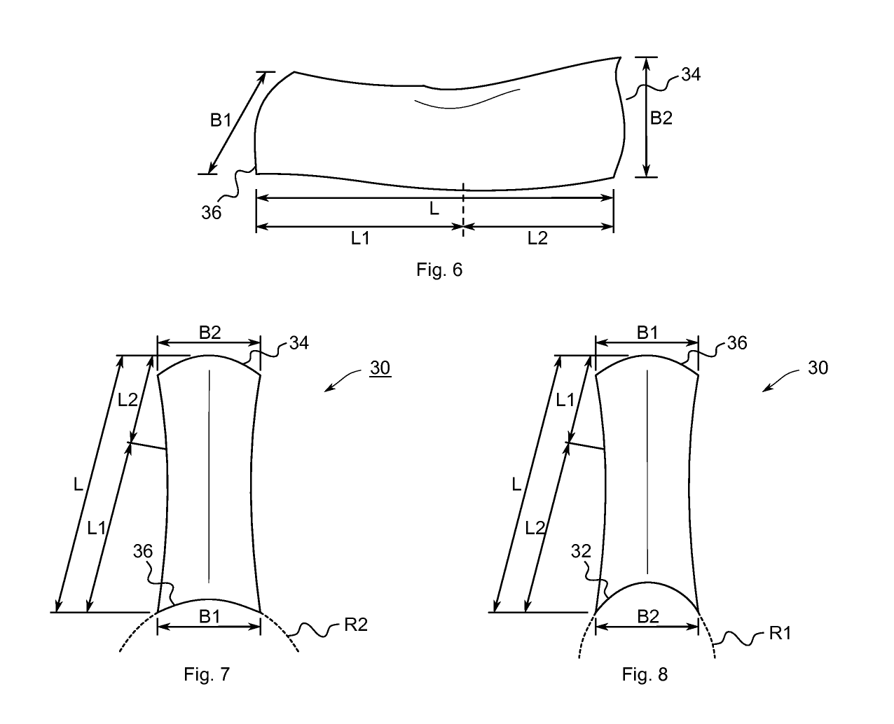

It is clearly discernible that the cushion 1 extends towards the top along the central line M in the form of a central channel towards the frontal end 34 and/or section. This is achieved by a bowl-shaped formed part 30, as explained in greater detail in FIGS. 6 to 8. This formed part 30 is provided in a pocket-like opening 18 of the mount 1, with the pocket-like opening 18 extending along the central line M within the cushion 1. This is illustrated in the following figures. The pocket-like opening 18 is closed at its one end 20, in the area of the rear end 36 of the cushion 1, e.g. sewn.

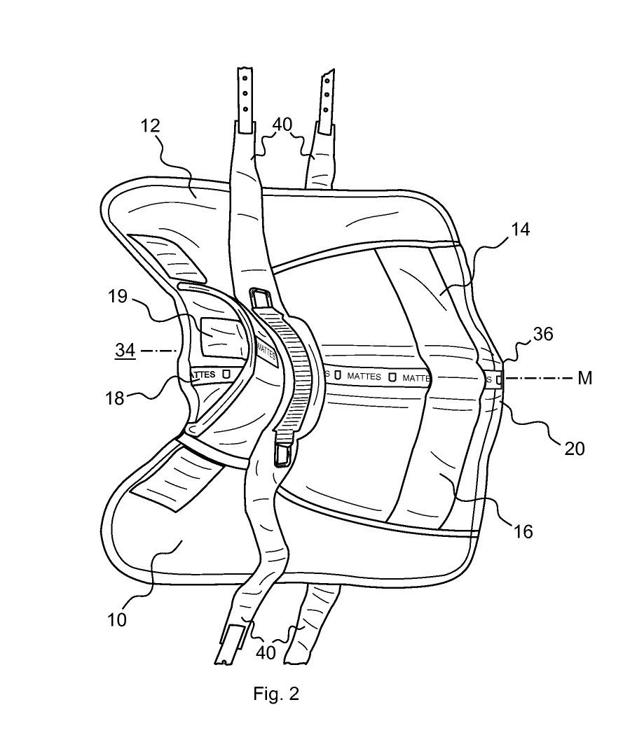

FIG. 2 shows the cushion 1 with the formed part removed and a widely expanded pocket-like opening 18. At the top and the bottom, once more the two lateral parts 10, 12 are discernible. Also visible are the two upholstery parts 14, 16 and/or upholstery pockets, applied on the textile web. Discernible at the left side is the widely open, pocket-like opening 18, which extends to the frontal end 20 of the cushion 1. The formed part can be inserted into this pocket-like opening 18. The right end 20 of the pocket-like opening 18 is closed, for example sewn, so that the formed part to be inserted in the opening 18 cannot slip out of the cushion 1. When the formed part is inserted completely in the pocket-like opening 18, said opening can be closed via the Velcro-closure 19 shown in FIG. 2.

Additionally, two straps 40 are shown in FIG. 2, which are fastened at the cushion 1.

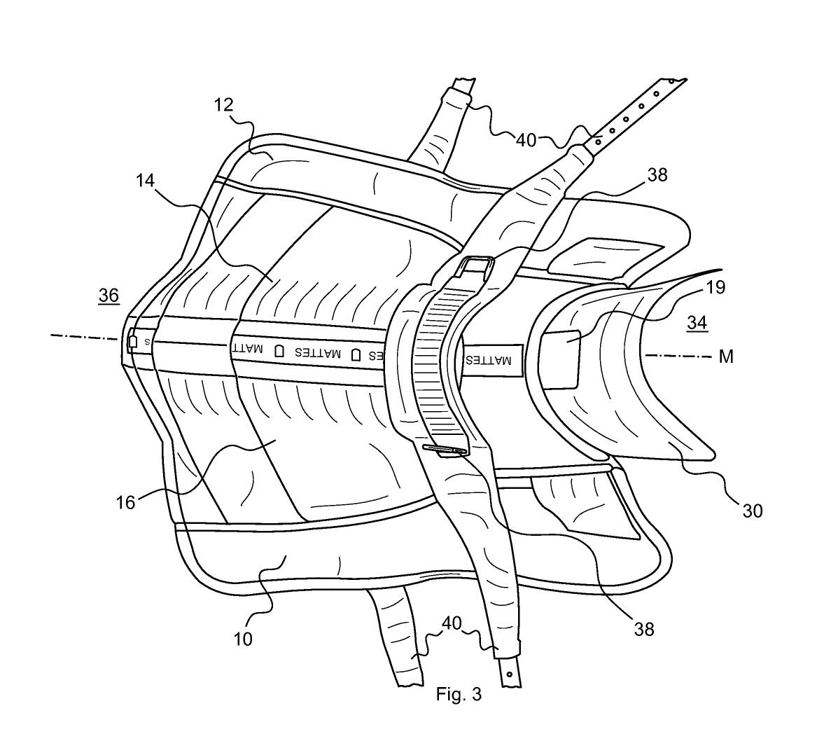

FIG. 3 shows the above-discussed cushion 1 with a formed part 30 already largely inserted. The reference characters already known once more represent the same parts.

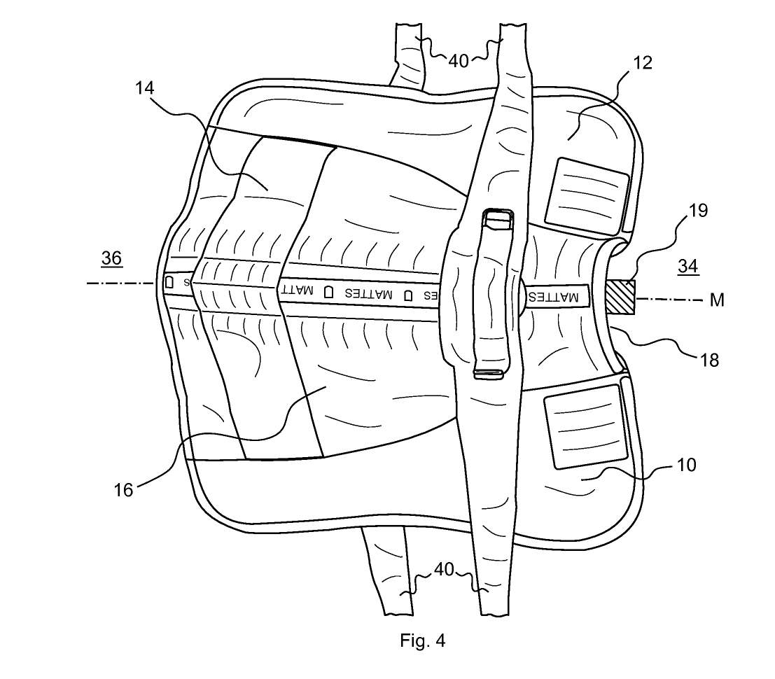

FIG. 4 shows a cushion 1 with a view to the top, with the formed part not being inserted in the pocket-like opening 18. Additionally, the straps 40 are discernible laterally projecting from the cushion 1. Additionally, square rings are discernible for the stirrup fastenings, which are fastened at both sides at the straps 40 guided via the formed part 30.

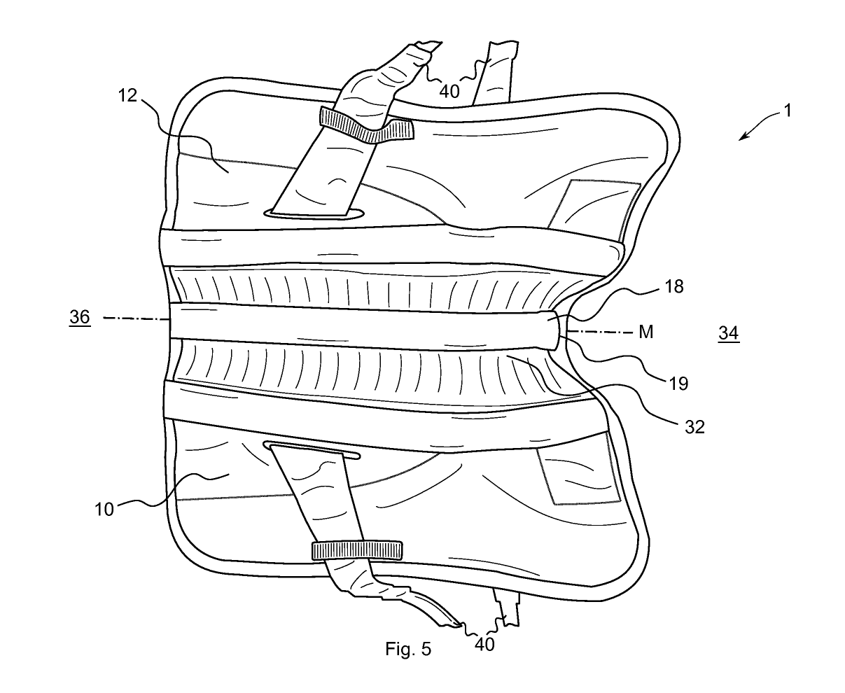

FIG. 5 shows the cushion 1 with a view to its bottom, with the quilted textile web and the concave and/or bowl-shaped structure of the cushion 1 being discernible in the area of the central line M. The formed part 30 inserted into the cushion 1 is responsible for this effect.

This bowl-shaped structure is particularly clearly discernible in the view of FIG. 5a.

FIGS. 6, 7, and 8 show the above-mentioned formed part 30 in different views. The formed part 30 is made from plastic, for example injection molded or deep drawn. However, this formed part 30 may also be made from other materials, e.g. metal or the like or from a mixture of these materials.

It is clearly discernible in the figures that the formed part 30 is embodied concavely and/or bowl-shaped and that its cross-section shows a U-form or a bowl-shaped form. The radius R1 is smaller at the frontal end 34 of the formed part 30 than the radius R2 at the rear end 36 of the formed part 30. This means nothing else but the frontal end 34 of the formed part 30 being curved more strongly than the rear end 36. As additionally discernible from FIGS. 6, 7, and 8 the formed part 30 widens from its rear end 36 towards its frontal end 34. The width at the rear end is B1. The width at the frontal end is marked with the reference character B2. B2 is greater than B1. The formed part 30 extends therefore conically from the rear end 36 towards the frontal end 34.

The formed part 30 shows overall a length L1, which is however angled and/or curved upwards in a frontal section. The section not curved upwards shows a length L1. The section curved upwards shows a length L2. The length L2 is shorter than the length L1.

Such a shape of the formed part 30 considers the fact that the formed part 30, upon placement onto the back of the mount, can very well follow the withers of the mount extending upwards and a respective distance from said withers is ensured. The formed part 30 is designed approximately showing the same length as the length of the cushion 1 along the central line M.

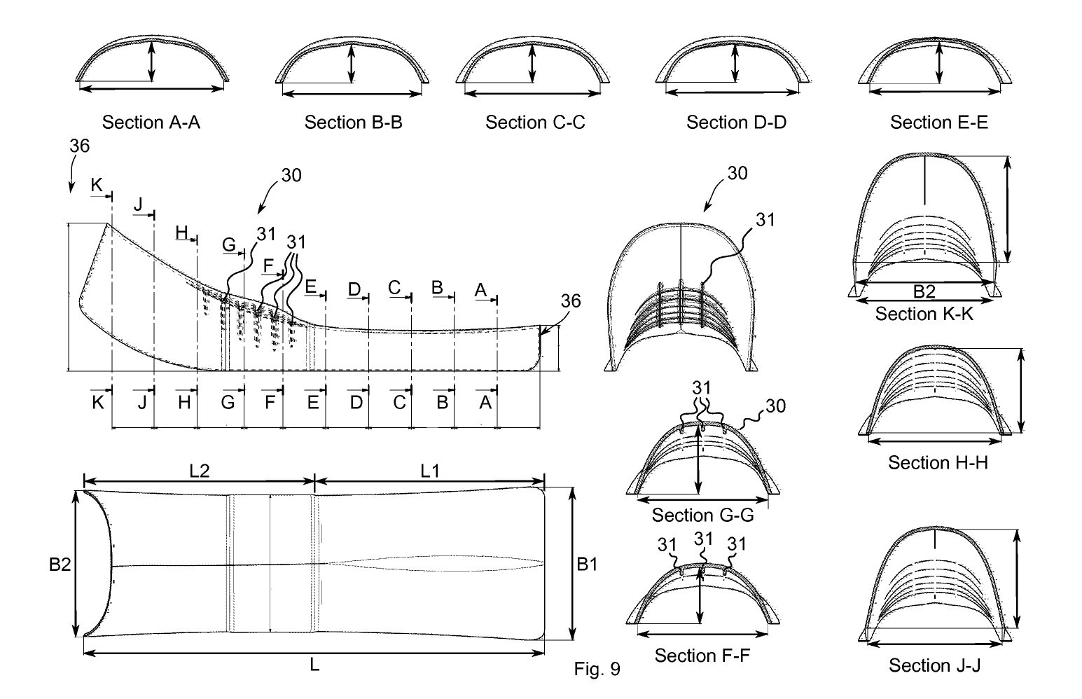

FIG. 9 shows a concrete exemplary embodiment of a suitable formed part 30 in different views. The formed part 30 shows an overall length L, with a first section L1, starting at the rear end 36 with a rear width B1, extending essentially in a straight fashion. The formed part 30 is curved upwards towards the frontal end 34, namely over a length L2. The rear width of the formed part 30 is marked B1 and the frontal width of the formed part is marked B2. Directly abutting the straight part of the formed part 30, a section with reinforcement elements 31 is arranged, which in the present case is embodied in the form of reinforcement ribs. These reinforcement ribs 31 project towards the interior of the bowl-shaped section of the formed part 30 and strengthen the formed part 30.

In a side view of FIG. 9 of the formed part 30 a plurality of cross-sections A-A to K-K are illustrated. It is clearly discernible that the formed part 30, starting at the cross-section A-A, initially extends relatively flat in a bowl-shaped fashion until approximately to the cross-section E-E. Already in the following cross-section F-F the bending radius is greater and the depth of the bowl-shaped bending is also greater. Simultaneously the width of the formed part 30 reduces slightly. In the cross-sections of F-F and G-G the reinforcement elements and/or reinforcement ribs 31 are particularly clearly discernible, which project into the bowl-shaped recess. The lowest bowl-shaped section is then discernible in the cross-section K-K. The formed part 30 shown in FIG. 9 is preferably an injection molded part comprising plastic. If applicable, reinforcing materials may be embedded in said plastic, e.g., metal particles or fiberglass.

### LIST OF REFERENCE NUMBERS

1 Cushion (Pillion)
10 first lateral part
12 second lateral part
14 upholstering
16 upholstering
18 pocket-like opening
19 Velcro closure
20 frontal end of the pocket-like opening
30 bowl-shaped formed part
31 reinforcement elements
32 bowl-shaped curve
34 frontal end
36 rear end
38 square strap
40 stirrup strap, belt
M central line
B1 rear width of the formed part
B2 frontal width of the formed part
L length of the formed part
L1 length of the straight part
L2 length of the part curved upwards
R1 radius, front
R2 radius, rear

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A cushion for placement on a mount with two lateral parts made from a flexible material, particularly a textile material, which are connected to each other, wherein a formed part is fastened in or at the cushion in the area and at least approximately along the entire central line of the cushion.

2. The cushion of claim 1, wherein the formed part is embodied at least U-shaped or bowl-shaped seen in the cross-section.

3. The cushion of claim 1, wherein the formed part shows a first rear section with a length, and a second frontal section with a length, with the frontal section extending in one piece from the rear section curved or bent upwards.

4. The cushion of claim 1, wherein the formed part widens from the rear section towards the frontal section with a rear width and a frontal larger width.

5. The cushion of claim 1, wherein the formed part comprises a bowl-shaped bend, with its radius in the frontal section being smaller than the radius in the rear section.

6. The cushion of claim 1, wherein the formed part is made from plastic or metal or a combination of these materials.

7. The cushion of claim 1, wherein the cushion comprises a pocket-like opening along its central line, in which the formed part is inserted.

8. The cushion of claim 7, wherein the pocket-like opening is sewn or otherwise closed at a frontal or rear end of the cushion.

9. The cushion of claim 7, wherein that the pocket-like opening can be closed by a Velcro-closure.

10. The cushion of claim 1, wherein the cushion comprises on its top and/or bottom fastening means for fastening the formed part.

11. The cushion of claim 1, wherein the cushion comprises strap openings on each of the two lateral parts for guiding straps through them.

12. The cushion of claim 1, wherein each of the two lateral parts of the cushion show upholstery.
